(19) United States
(12) Patent Application Publication
(10) Pub. No.: US 2014/0027505 A1
(43) Pub. Date: Jan. 30, 2014

(54) Configuration Management Systems And Methods for Electronic Devices

(71) Applicant: Pei-Tzu Kuo, Taichung City (TW)

(72) Inventor: Pei-Tzu Kuo, Taichung City (TW)

(73) Assignee: SINTAI OPTICAL (SHENZHEN) CO., LTD., Shenzhen City (CN)

(21) Appl. No.: 13/561,136

(22) Filed: Jul. 30, 2012

(51) Int. Cl. G06F 17/00; G06K 19/07; G06K 19/06

(52) U.S. Cl. 235/375; 235/494; 235/492

(57) ABSTRACT

Configuration management systems and methods for electronic devices are provided. In some embodiments, a storage unit of an electronic device stores at least one configuration corresponding to the electronic device. The at least one configuration is encoded into barcode data according to an encoding rule, and the barcode data is output to a carrier via an output unit of the electronic device. In some embodiments, a reception unit of the electronic device obtains barcode data. A processing unit of the electronic device decodes the barcode data into a configuration according to a decoding rule, and sets the electronic device according to the configuration.

### BACKGROUND OF THE INVENTION

1. Field of the Invention

The disclosure relates generally to configuration management systems and methods for electronic devices, and more particularly, to systems and methods that output barcode data corresponding to configurations by electronic devices, and/or directly perform related settings for electronic devices using external barcode data.

2. Description of the Related Art

Recently, with the development of technology, electronic devices having a variety of capabilities have become necessities of life. For example, a digital camera having a light and thin volume can conveniently take photos, and the photos can be viewed and processed in related devices, such as computer systems. Additionally, TVs/displayers can play prerecording data, such as movies stored in CD, DVD, and so on. Further, users can use a TV having a network connection capability to link with an Internet, and perform related network services. Furthermore, some devices may have a projection capability, such as projectors or cameras. Users can project data, photos or movies for viewing via these devices.

Generally, respective users may have their own preference when operating an electronic device. For example, for respective users, the brightness or contrast of a display of the electronic device may be different. Therefore, conventionally, the electronic device can provide an interface, which can be used for setting internal configurations of the electronic device. Users can adjust and set respective parameters in the configurations via the interface, such that the electronic device can be operated in the favorite modes of users.

However, some electronic devices may be provided for several users, and respective user can set its own configuration on an electronic device. In some situations, since the configuration on the electronic device may be modified by other users, a user may frequently perform the setting of configuration on the same electronic device. These troublesome and complicate setting procedures are always inconvenient for users.

### BRIEF SUMMARY OF THE INVENTION

Configuration management systems and methods for electronic devices are provided. An electronic device can output barcode data corresponding to a configuration, and/or the electronic device can be directly performed with related settings using external barcode data, thus to avoid repeated and complicate manual setting procedures, and speed up the setting time of configuration for the electronic device.

An embodiment of a configuration management system for electronic devices comprises a storage unit, an output unit, and a processing unit. The storage unit stores at least one configuration corresponding to the electronic device. The processing unit encodes the at least one configuration into barcode data according to an encoding rule. The output unit outputs the barcode data to a carrier.

In an embodiment of a configuration management method for electronic devices, at least one configuration corresponding to an electronic device is provided. The at least one configuration is encoded into barcode data according to an encoding rule. Then, the barcode data is output to a carrier.

In some embodiments, the output unit can comprise a printer, and the carrier can comprise a printable medium. The printer prints the barcode data on the printable medium.

In some embodiments, the output unit can comprise a RFID (radio-frequency identification) transceiver, and the carrier can comprise a RFID tag. The RFID transceiver transmits the barcode data to the RFID tag.

In some embodiments, the output unit can comprise a USB (Universal Serial Bus) unit, and the carrier can comprise a portable storage unit. The USB unit transmits the barcode data to the portable storage unit.

In some embodiments, the output unit can comprise a micro projecting module, and the carrier can comprise a project screen. The micro projecting module projects the barcode data on the project screen.

In some embodiments, the output unit can comprise an image output unit, and the carrier can comprise a display module. The image output unit transmits the barcode data to the display module for display.

An embodiment of a configuration management system for electronic devices comprises a reception unit and a processing unit. The reception unit obtains barcode data from a carrier. The processing unit decodes the barcode data into a configuration according to a decoding rule, and sets the electronic device according to the configuration.

In an embodiment of a configuration management method for electronic devices, barcode data is obtained from a carrier. Then, the barcode data is decoded into a configuration according to a decoding rule, and the electronic device is set according to the configuration.

In some embodiments, the reception unit can comprise a scan module or an image capture module, and perform a scan operation or a photograph operation to the carrier, thus to obtain an image corresponding to the barcode data. The processing unit can analyze the image to obtain the barcode data.

In some embodiments, the reception unit can comprise a RFID transceiver, and the carrier can comprise a RFID tag. The RFID transceiver obtains the barcode data from the RFID tag.

In some embodiments, the reception unit can comprise a USB unit, and the carrier can comprise a portable storage unit. The USB unit obtains the barcode data from the portable storage unit.

Configuration management methods for electronic devices may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram of an embodiment of a configuration management system for electronic devices of the invention;

FIG. 2 is a flowchart of an embodiment of a configuration management method for electronic devices of the invention;

FIG. 3 is a schematic diagram of another embodiment of a configuration management system for electronic devices of the invention;

FIG. 4 is a flowchart of another embodiment of a configuration management method for electronic devices of the invention; and

FIG. 5 is a schematic diagram of another embodiment of a configuration management system for electronic devices of the invention.

### DETAILED DESCRIPTION OF THE INVENTION

Configuration management systems and methods for electronic devices are provided.

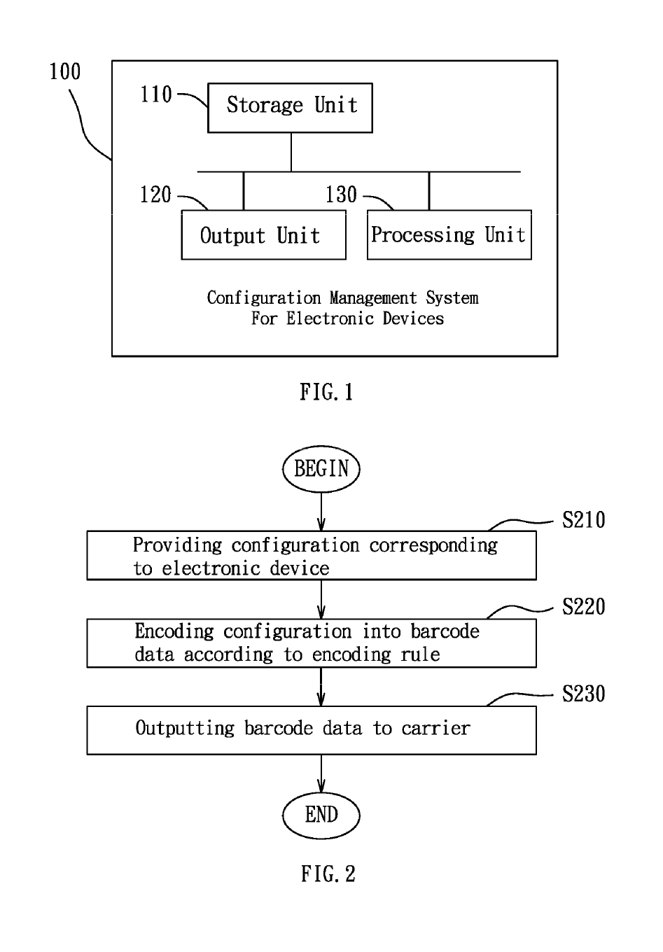

FIG. 1 is a schematic diagram of an embodiment of a configuration management system for electronic devices of the invention. The configuration management system for electronic devices 100 can be used in an electronic device, such as digital cameras, TVs/displayers, mobile devices, such as mobile phones, and electronic devices having project capability, such as projectors and cameras. In this embodiment, the electronic device can output barcode data corresponding to a configuration.

The configuration management system for electronic devices 100 comprises at least a storage unit 110, an output unit 120, and a processing unit 130. The storage unit 110 can record at least one configuration. It is understood that, in some embodiments, the configuration can comprise at least one setting item. As described, the electronic device may be a digital camera, TV/displayer, mobile phone or projector. In some embodiments, when the electronic device is a digital camera, the setting items in the configuration can comprise the scene mode, focus, exposure value, aperture value, shutter speed, flash setting, continuous shooting setting, storage size, and/or red-eye correction setting. In some embodiments, when the electronic device is a TV/displayer, the setting items in the configuration can comprise the brightness, contrast, bilingual mode, sound, Internet, channel list, and/or languages. In some embodiments, when the electronic device is a mobile phone, the setting items in the configuration can comprise the phone setting, display setting, and/or communication setting. In some embodiments, when the electronic device is a projector, the setting items in the configuration can comprise the color management, color temperature, Gamma, contrast, brightness, chroma, hues, aperture adjustment, lamp power, image position, image surface, focusing/zooming/shifting of lens, pixel adjust, keystone correction, distortion, language, menu position, and/or network. It is understood that, the above electronic devices and the setting items in the corresponding configurations are examples of the application, and the present invention is not limited thereto.

In some embodiments, the configuration management system for electronic devices 100 can further comprise an input unit (not shown in FIG. 1), such as a button set on the electronic device or a remote controller corresponding to the electronic device. Users can generate/set the configuration via the input unit. Additionally, in some embodiments, the configuration management system for electronic devices 100 can further comprise a display unit (not shown in FIG. 1), used for displaying the generation/setting process corresponding to the configuration.

The processing unit 130 can encode the configuration into barcode data according to an encoding rule. It is noted that, in some embodiments, the barcode data may be a one dimensional barcode, a two dimensional barcode, such as a QR (Quick Response) code, or a barcode with any dimension, and the encoding rule can be used to transform a series of letters/numbers into the barcode data. The output unit 120 can output the barcode data to a carrier. In some embodiments, the output unit 120 may be a printer, and the carrier may be a printable medium, such as paper. The printer prints the barcode data on the printable medium. In some embodiments, the output unit 120 may be a RFID transceiver, and the carrier may be a RFID tag. The RFID transceiver transmits the barcode data to the RFID tag. It is understood that, in some implementations, the RFID transceiver can be also called as a RFID receiver or a RFID reader, which can be implemented logics of reading data from RFID tags, and writing data to RFID tags. In some embodiments, the output unit 120 may be a USB unit, and the carrier may be a portable storage unit. The USB unit transmits the barcode data to the portable storage unit. In some embodiments, the output unit 120 may be a micro projecting module, and the carrier may be a project screen. The micro projecting module projects the barcode data on the project screen. In some embodiments, the output unit 120 may be an image output unit, and the carrier may be a display module. The image output unit transmits the barcode data to the display module for display. It is noted that, the above output unit 120 and the corresponding carrier are examples of the present application, and the present invention is not limited thereto.

FIG. 2 is a flowchart of an embodiment of a configuration management method for electronic devices of the invention. The configuration management method for electronic devices can be used in an electronic device, such as digital cameras, TVs/displayers, mobile devices, such as mobile phones, and electronic devices having project capability, such as projectors and cameras. In this embodiment, the electronic device can output barcode data corresponding to a configuration.

In step S210, at least one configuration corresponding to an electronic device is provided. As described, when the electronic device is a digital camera, the setting items in the configuration can comprise the scene mode, focus, exposure value, aperture value, shutter speed, flash setting, continuous shooting setting, storage size, and/or red-eye correction setting. When the electronic device is a TV/displayer, the setting items in the configuration can comprise the brightness, contrast, bilingual mode, sound, Internet, channel list, and/or languages. When the electronic device is a mobile phone, the setting items in the configuration can comprise the phone setting, display setting, and/or communication setting. When the electronic device is a projector, the setting items in the configuration can comprise the color management, color temperature, Gamma, contrast, brightness, chroma, hues, aperture adjustment, lamp power, image position, image surface, focusing/zooming/shifting of lens, pixel adjust, keystone correction, distortion, language, menu position, and/or network.

It is understood that, in some embodiments, users can generate/set the configuration via an input unit, such as a button set on the electronic device or a remote controller corresponding to the electronic device. In some embodiments, the generation/setting process corresponding to the configuration can be displayed via a display unit.

In step S220, the configuration is encoded into barcode data according to an encoding rule. Similarly, in some embodiments, the barcode data may be a one dimensional barcode, a two dimensional barcode, such as a QR (Quick Response) code, or a barcode with any dimension, and the encoding rule can be used to transform a series of letters/numbers into the barcode data. Then, in step S230, the barcode data corresponding to the configuration is output to a carrier. It is understood that, in some embodiments, the barcode data is output to a carrier via an output unit in step S230. In some embodiments, the output unit can comprise a printer, a RFID transceiver, a USB unit, a micro projecting module, and/or an image output unit. In some embodiments, the carrier can comprise a printable medium, a RFID tag, a portable storage unit, a project screen, and/or a display module. It is noted that, the above output unit and the corresponding carrier are examples of the present application, and the present invention is not limited thereto.

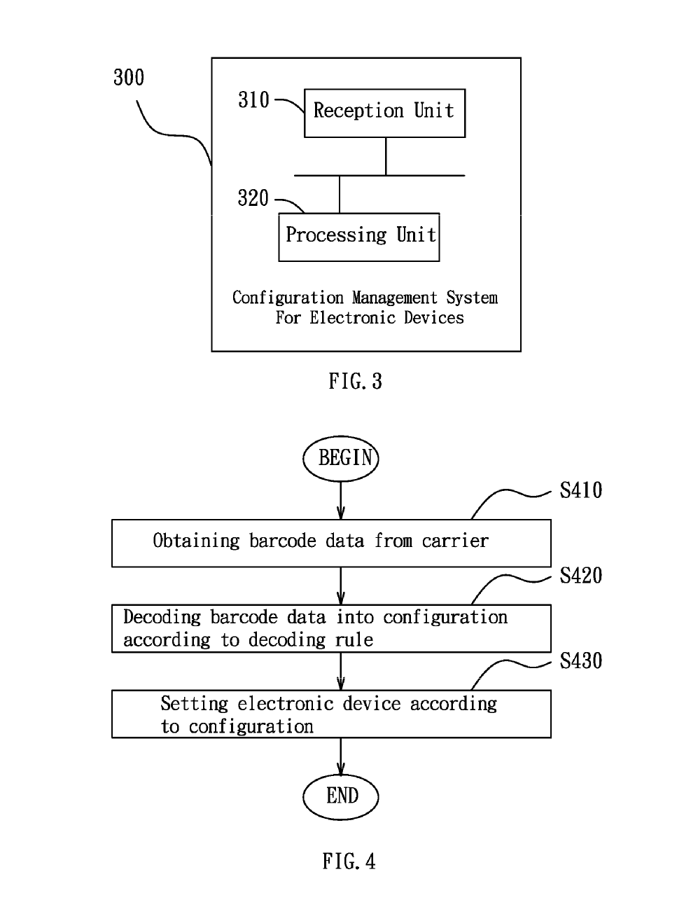

FIG. 3 is a schematic diagram of another embodiment of a configuration management system for electronic devices of the invention. The configuration management system for electronic devices 300 can be used in an electronic device, such as digital cameras, TVs/displayers, mobile devices, such as mobile phones, and electronic devices having project capability, such as projectors and cameras. In this embodiment, the electronic device can receive barcode data corresponding to a configuration, and accordingly perform related settings.

The configuration management system for electronic devices 300 comprises at least a reception unit 310 and a processing unit 320. The reception unit 310 can obtain barcode data from a carrier. It is understood that, in some embodiments, the reception unit-310 may be a scan module or an image capture module, and the carrier may be a printable medium, such as paper. The scan module or the image capture module can perform a scan operation or a photograph operation to the printable medium, thus to obtain an image corresponding to the barcode data. In some embodiments, the carrier may be a project screen or a display module, wherein the project screen or the display module has a display corresponding to the barcode data. Similarly, the image capture module can perform a photograph operation to the project screen or the display module, thus to obtain an image corresponding to the barcode data. The processing unit 320 can analyze the image to obtain the barcode data. It is noted that, in some embodiments, the reception unit 310 may be a RFID transceiver, and the carrier may be a RFID tag. The RFID transceiver can obtain the barcode data from the RFID tag. In some embodiments, the reception unit 310 may be a USB unit, and the carrier can comprise a portable storage unit. The USB unit can obtain the barcode data from the portable storage unit. It is understood that, the above reception unit 310 and the corresponding carrier are examples of the present application, and the present invention is not limited thereto. After the barcode data is obtained, the processing unit 320 can decode the barcode data into a configuration according to a decoding rule. It is noted that, in some embodiments, the barcode data may be a one dimensional barcode, a two dimensional barcode, or a barcode with any dimension, and the decoding rule can be used to transform the barcode data into a series of letters/numbers. Note that, the configuration may be various according to different electronic devices, and related descriptions are omitted here. After the configuration is obtained, the processing unit 320 can set the electronic device according to the configuration. Additionally, in some embodiments, the configuration management system for electronic devices 300 can further comprise a display unit (not shown in FIG. 3), used for displaying the received barcode data or the configuration.

FIG. 4 is a flowchart of another embodiment of a configuration management method for electronic devices of the invention. The configuration management method for electronic devices can be used in an electronic device, such as digital cameras, TVs/displayers, mobile devices, such as mobile phones, and electronic devices having project capability, such as projectors and cameras. In this embodiment, the electronic device can receive barcode data corresponding to a configuration, and accordingly perform related settings

In step S410, barcode data is obtained from a carrier. It is understood that, in some embodiments, the barcode data is obtained from the carrier via a reception unit. In some embodiments, the reception unit may be a scan module or an image capture module, and the carrier may be a printable medium. The scan module or the image capture module can perform a scan operation or a photograph operation to the printable medium, thus to obtain an image corresponding to the barcode data. In some embodiments, the carrier may be a project screen or a display module, wherein the project screen or the display module has a display corresponding to the barcode data. Similarly, the image capture module can perform a photograph operation to the project screen or the display module, thus to obtain an image corresponding to the barcode data. The image can be analyzed to obtain the barcode data. It is noted that, in some embodiments, the reception unit 310 may be a RFID transceiver, and the carrier may be a RFID tag. The RFID transceiver can obtain the barcode data from the RFID tag. In some embodiments, the reception unit 310 may be a USB unit, and the carrier can comprise a portable storage unit. The USB unit can obtain the barcode data from the portable storage unit. It is understood that, the above reception unit 310 and the corresponding carrier are examples of the present application, and the present invention is not limited thereto. In step S420, the barcode data is decoded into a configuration according to a decoding rule. Similarly, in some embodiments, the barcode data may be a one dimensional barcode, a two dimensional barcode, or a barcode with any dimension, and the decoding rule can be used to transform the barcode data into a series of letters/numbers. Note that, the configuration may be various according to different electronic devices, and related descriptions are omitted here. After the configuration is obtained, in step S430, the electronic device is set according to the configuration.

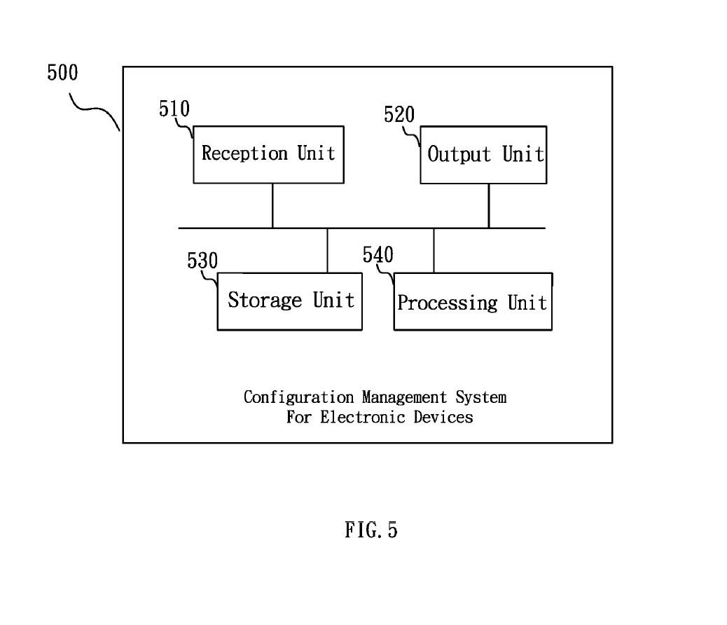

FIG. 5 is a schematic diagram of another embodiment of a configuration management system for electronic devices of the invention. The configuration management system for electronic devices 500 can be used in an electronic device, such as digital cameras, TVs/displayers, mobile devices, such as mobile phones, and electronic devices having project capability, such as projectors and cameras. In this embodiment, the electronic device can output barcode data corresponding to a configuration, and efficiently complete the setting of configuration for the electronic device using the output barcode data.

The configuration management system for electronic devices 500 comprises at least a reception unit 510, an output unit 520, a storage unit 530, and a processing unit 540. Users can generate/set the configuration via an input unit (not shown), such as a button set on the electronic device or a remote controller corresponding to the electronic device. It is understood that, the configuration can comprise at least one setting item. The configuration may be various according to different electronic devices, and the present invention is not limited to any electronic device or corresponding configuration. In some embodiments, storage unit 530 can temporarily store the configuration. The processing unit 540 can encode the configuration into barcode data, such as a two dimensional barcode of QR code according to an encoding rule. The processing unit 540 can output the barcode data to a carrier via the output unit 520. Similarly, in some embodiments, the output unit 520 may be a printer, and the carrier may be a printable medium, such as paper. The printer prints the barcode data on the printable medium. In some embodiments, the output unit 520 may be a RFID transceiver, and the carrier may be a RFID tag. The RFID transceiver transmits the barcode data to the RFID tag. In some embodiments, the output unit 520 may be a USB unit, and the carrier may be a portable storage unit. The USB unit transmits the barcode data to the portable storage unit. In some embodiments, the output unit 520 may be a micro projecting module, and the carrier may be a project screen. The micro projecting module projects the barcode data on the project screen. In some embodiments, the output unit 520 may be an image output unit, and the carrier may be a display module. The image output unit transmits the barcode data to the display module for display. It is noted that, the above output unit 520 and the corresponding carrier are examples of the present application, and the present invention is not limited thereto.

When the electronic device wants to perform the setting of configuration, the electronic device can obtain barcode data from a carrier via the reception unit 510. Similarly, in some embodiments, the reception unit 510 may be a scan module or an image capture module, and the carrier may be a printable medium, such as paper. The scan module or the image capture module can perform a scan operation or a photograph operation to the printable medium, thus to obtain an image corresponding to the barcode data. In some embodiments, the carrier may be a project screen or a display module, wherein the project screen or the display module has a display corresponding to the barcode data. Similarly, the image capture module can perform a photograph operation to the project screen or the display module, thus to obtain an image corresponding to the barcode data. The processing unit 540 can analyze the image to obtain the barcode data. In some embodiments, the reception unit 510 may be a RFID transceiver, and the carrier may be a RFID tag. The RFID transceiver can obtain the barcode data from the RFID tag. In some embodiments, the reception unit 510 may be a USB unit, and the carrier can comprise a portable storage unit. The USB unit can obtain the barcode data from the portable storage unit. It is understood that, the above reception unit 510 and the corresponding carrier are examples of the present application, and the present invention is not limited thereto. It is noted that, when the output unit 520 and the input unit 510 are both RFID transceivers, the output unit 520 and the input unit 510 can be integrated. Additionally, when the output unit 520 and the input unit 510 are both USB units, the output unit 520 and the input unit 510 can be integrated. After the barcode data is obtained, the processing unit 540 decodes the barcode data into a configuration according to a decoding rule, and sets the electronic device according to the configuration. It is noted that, in some embodiments, the obtained barcode data and/or the decoded configuration can be display via a display unit (not shown).

It is understood that, since the micro projecting module is always integrated with a mobile device, and has a limited size and less operational buttons, it is inconvenient for users to perform related settings of configuration by using the operational buttons of the micro projecting device. Further, since the electronic device having an image capture module such as a mobile device is popular, users can output the barcode data via the micro projecting module of the electronic device, and input the barcode data as an image to the electronic device via the image capture module, thus to accordingly perform related settings. In this way, a more efficient and simple setting manner for configuration can be provided.

Therefore, the configuration management systems and methods for electronic devices can output barcode data corresponding to configurations by electronic devices, and/or directly perform related settings for electronic devices using external barcode data, thus to avoid repeated and complicate manual setting procedures, and speed up the setting time of configuration for the electronic device.

Configuration management methods for electronic devices, or certain aspects or portions thereof, may take the form of a program code (i.e., executable instructions) embodied in tangible media, such as floppy disks, CD-ROMs, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A configuration management system for electronic devices for use in an electronic device, comprising:
a storage unit storing at least one configuration corresponding to the electronic device;
a processing unit encoding the at least one configuration into barcode data according to an encoding rule; and
an output unit outputting the barcode data to a carrier,
wherein the barcode data is used to set the electronic device.

2. The system of claim 1, further comprising an input unit for receiving an input corresponding to the at least one configuration.

3. The system of claim 1, wherein the barcode data comprises a one dimensional barcode or a two dimensional barcode.

4. The system of claim 1, wherein the output unit comprises a printer, the carrier comprises a printable medium, and the printer prints the barcode data on the printable medium.

5. The system of claim 1, wherein the output unit comprises a RFID transceiver, the carrier comprises a RFID tag, and the RFID transceiver transmits the barcode data to the RFID tag.

6. The system of claim 1, wherein the output unit comprises a USB unit, the carrier comprises a portable storage unit, and the USB unit transmits the barcode data to the portable storage unit.

7. The system of claim 1, wherein the output unit comprises a micro projecting module, the carrier comprises a project screen, and the micro projecting module projects the barcode data on the project screen.

8. The system of claim 1, wherein the output unit comprises an image output unit, the carrier comprises a display module, and the image output unit transmits the barcode data to the display module for display.

9. A configuration management system for electronic devices for use-in an electronic device, comprising:
a reception unit obtaining barcode data from a carrier; and
a processing unit decoding the barcode data into a configuration according to a decoding rule, and setting the electronic device according to the configuration.

10. The system of claim 9, wherein the reception unit comprises a scan module or an image capture module, and performs a scan operation or a photograph operation to the carrier, thus to obtain an image corresponding to the barcode data, and the processing unit analyzes the image to obtain the barcode data.

11. The system of claim 9, wherein the reception unit comprises a RFID transceiver, the carrier comprises a RFID tag, and the RFID transceiver obtains the barcode data from the RFID tag.

12. The system of claim 9, wherein the reception unit comprises a USB unit, the carrier comprises a portable storage unit, and the USB unit obtains the barcode data from the portable storage unit.

13. The system of claim 9, further comprising a display unit, for displaying the barcode data or the configuration.

14. The configuration management method for electronic devices for use-in an electronic device, the method comprising:
providing at least one configuration corresponding to the electronic device;
encoding the at least one configuration into barcode data according to an encoding rule; and
outputting the barcode data to a carrier,
wherein the barcode data is used to set the electronic device.

15. The method of claim 14, further comprising receiving an input corresponding to the at least one configuration via an input unit.

16. The method of claim 14, wherein the barcode data comprises a one dimensional barcode or a two dimensional barcode.

17. The method of claim 14, further comprising printing the barcode data on a printable medium via a printer.

18. The method of claim 14, further comprising transmitting the barcode data to a RFID tag via a RFID transceiver.

19. The method of claim 14, further comprising transmitting the barcode data to a portable storage unit via a USB unit.

20. The method of claim 14, further comprising projecting the barcode data on a project screen via a micro projecting module.

21. The method of claim 14, further comprising transmitting the barcode data to a display module for display via an image output unit.

22. A configuration management method for electronic devices for use in an electronic device, the method comprising:
obtaining barcode data from a carrier;
decoding the barcode data into a configuration according to a decoding rule; and
setting the electronic device according to the configuration.

23. The method of claim 22, further comprising:
performing a scan operation or a photograph operation to the carrier via a scan module or an image capture module, thus to obtain an image corresponding to the barcode data; and
analyzing the image to obtain the barcode data.

24. The method of claim 22, further comprising obtaining the barcode data from a RFID tag via a RFID transceiver.

25. The method of claim 22, further comprising obtaining the barcode data from a portable storage unit via a USB unit.

26. The method of claim 22, further comprising displaying the barcode data or the configuration via a display unit.
